(19) United States
(12) Patent Application Publication
(10) Pub. No.: US 2007/0008456 A1
(43) Pub. Date: Jan. 11, 2007

(54) ILLUMINATION SYSTEM AND A DISPLAY INCORPORATING THE SAME

(76) Inventors: Etienne Lesage, Franconville (FR); Jonathan Mather, Oxford (GB)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/428,868

(22) Filed: Jul. 6, 2006

(30) Foreign Application Priority Data
Jul. 8, 2005 (GB) 0513964.7

(51) Int. Cl. G02F 1/1335

(52) U.S. Cl. 349/62

(57) ABSTRACT

An illumination system is providing comprising a first waveguide having a plurality of light-directing surfaces on its lower surface. These surfaces direct light through an output surface of the waveguide into at least one angular range while directing substantially no light into a different angular range. Each surface comprises a plurality of portions having different angles of inclination to a normal to the waveguide.

This Nonprovisional application claims priority under U.S.C. § 119(a) on Patent Application No. 0513964.7 filed in U.K. on Jul. 8, 2005, the entire contents of which are hereby incorporated by reference.

### FIELD OF THE INVENTION

The present invention relates to an illumination system for use in, for example, a display. The present invention also relates to a display incorporating an illumination system of the invention, and in particular to a display which is switchable between a private viewing mode and a public viewing mode.

### BACKGROUND OF THE INVENTION

Electronic display devices, such as monitors used with computers and screens built in to telephones and portable information devices, are usually designed to have a viewing angle as wide as possible, so that they can be read from as many viewing positions as possible. However, there are some situations where it is useful to have a display that is visible from only a narrow range of angles. For example, where a person is reading a confidential or private document on the display of a mobile device in a crowded place, they might wish to minimise the risk of others around them also having sight of the document on the display.

It is therefore useful to have a display that is switchable between two modes of operation. In a ‘public’ mode, the display would have a wide viewing angle for general use. In a ‘private’ mode, the display would have a narrow viewing angle, so that private information could be read in a public place. For example, the display could automatically go into the private mode when certain secure web pages are accessed (c.g. bank site web pages), or when a certain PIN (personal identification number) is input to the keyboard (e.g. bank account PIN). In the private mode, an indicator or icon could be shown on the screen to indicate that the private mode is active.

Liquid crystal display devices typically use cold cathode fluorescent tubes as backlights. They may use one tube and a waveguide, or multiple tubes with or without waveguides. The tubes are all of the same type and result in the same viewing angle properties for the display panel. Such arrangements are well known in the field.

FIG. 1 of the accompanying drawings illustrates a common illumination system used in mobile equipment. One (or more) fluorescent tubes 2 are placed at the side of a transmissive waveguide 4 including a reflective film 6 for reflecting the light towards a display panel 8. (The waveguide 4 may also be referred to as a “lightguide” or “light pipe”; the term “waveguide will be used herein.) The waveguide 4 is designed to distribute the light from the tube 2 evenly over the display panel 8, and typically provides wide or diffuse illumination. This may be achieved by controlling the structure of the waveguide 4 or modifying the top surface of the waveguide 4 so that it scatters light, or by the addition of a scattering layer 10 as shown in FIG. 1. Refractive and/or scattering elements distributed over the lightguide 4 may also be used. The illumination system of FIG. 1 also includes a brightness enhancing film (BEF) 12 which restricts the viewing angle and improves the brightness in a narrow viewing cone, and a protective diffuser 14 adjacent the display panel 8.

Such backlight arrangements are widely described in the literature, for example K. Kalantar in Proceeding of the SID, 2000, p. 1029, and various methods can be used to structure the lightguide 4 to give the required illumination. LED (light emitting diode) backlights are also considered as useful for illuminating LCD (liquid crystal display) device, and will be increasingly used in small displays, for example in mobile phones. Such backlights are also disclosed in U.S. Pat. No. 5,860,722 and US 2003/0160911.

A number of devices are known which restrict the range of angles or positions from which a display can be viewed. U.S. Pat. No. 6,552,850 describes a method for displaying private information on a cash dispensing machine. Light emitted by the machine's display has a fixed polarisation state, and the machine and its user are surrounded by a large screen of sheet polariser which absorbs light of that polarisation state but transmits the orthogonal state. Passers-by can see the user and the machine but cannot see information displayed on the screen.

Another method for controlling the direction of light is illustrated in FIG. 2 of the accompanying drawings in which a ‘louvred’ film 16 is placed between a backlight 18 and a transmissive image display panel 20. The film 16 consists of alternating transparent and opaque layers in an arrangement similar to a Venetian blind, allowing light to pass through the film 16 when the light is travelling in a direction nearly parallel to the layers, but absorbing light travelling at larger angles to the plane of the layers. These layers may be perpendicular to the surface of the film 16 or at some other angle. Thus, although the backlight 18 emits light with a wide angular distribution 22, light passing through the display panel 20 to a user 21 has a narrow angular distribution 23.

Louvred films may be manufactured by stacking many alternating sheets of transparent and opaque material and then cutting slices of the resulting block perpendicular to the layers. Such a method is described, for example, in U.S. Pat. No. 2,053,173, U.S. Pat. No. 2,689,387 and U.S. Pat. No. 3,031,351.

Other methods exist for making films with similar properties to the louvred film. For example, U.S. Pat. No. 5,147,716 describes a light-control film which contains many elongated particles which are aligned in a direction perpendicular to the plane of the film. Light rays which make large angles to this direction are strongly absorbed.

Another example of a light-control film is described in U.S. Pat. No. 5,528,319. Embedded in the transparent body of the light-control film are two or more layers parallel to the plane of the film, each layer having opaque and transparent sections. The opaque sections block the transmission of light through the film in certain directions while allowing the transmission of light in others.

The films described above may be placed either in front of a display panel, or between a transmissive display panel and its backlight, to restrict the range of angles from which the display can be viewed. In other words, they make a display ‘private’. However, none of them can easily be switched off to allow viewing from a wide range of angles.

It is desirable to provide a display which can be switched between a public mode (with a wide viewing angle) and a private mode (with a narrow viewing angle).

US 2002/0158967 describes how a light control film can be mounted on a display so that the light control film can be moved over the front of the display to provide a private mode, or mechanically retracted into a holder behind or beside the display to provide a public mode. The disadvantage of this arrangement is that it contains moving parts which may fail or be damaged, and it also results in a bulky display.

One previously-considered method for switching from public to private mode without moving parts is to mount a light control film behind the display panel, and to place a diffuser which can be electronically switched on and off between the light control film and the panel. When the diffuser is inactive, the light control film restricts the range of viewing angles and the display is then in the private mode. When the diffuser is switched on, it causes light travelling at a wide range of angles to pass through the panel and the display is then in the public mode. It is also possible to mount the light control film in front of the panel and place the switchable diffuser in front of the light control film to achieve the same effect.

Switchable privacy devices of these types are described in U.S. Pat. No. 5,831,698, U.S. Pat. No. 6,211,930 and U.S. Pat. No. 5,877,829. They share the disadvantage that the light control film absorbs a significant fraction of the light incident upon it, whether the display is in public or private mode, and the display is therefore inefficient in its use of light. Since the diffuser spreads light through a wide range of angles in the public mode, these displays are also dimmer in public than in private mode, unless the backlight is made brighter to compensate.

Another method for providing a switchable public/private display is described in U.S. Pat. No. 5,825,436, in which a light control device similar in structure to the louvred film described earlier is disclosed. However, each opaque element in the louvred film is replaced by a liquid crystal cell which can be electronically switched from an opaque state to a transparent state. The light control device is placed in front of or behind a display panel. When the cells are opaque, the display is in its private mode; when the cells are transparent, the display is in its public mode.

One disadvantage of this method is in difficulty and expense of manufacturing liquid crystal cells having a suitable shape. Another disadvantage is that, in the private mode, a ray of light may enter at an angle such that it passes first through the transparent material and then through part of a liquid crystal cell. Such a ray will not be completely absorbed by the liquid crystal cell and this may reduce the privacy of the device.

A public/private display device is disclosed in “A method for concealment of displayed data”, M. Dogruel, Displays 24, p. 97-102, 2003 in which both the private and public modes have a wide angular illumination range. To achieve the distinction between public and private mode, an authorised user is required to wear liquid crystal (LC) shutter glasses and a time sequence of images is presented on the display device as follows. Private and public mode images are time multiplexed in alternating frames, for example with a private mode image being shown in odd-numbered frames a public mode image being shown in even-numbered frames. The LC shutter glasses worn by an authorised user are operated to block even (public) frames and therefore the user sees only the time sequence of private frames. Non-users (those without authorisation to see private information and not wearing specially adapted LC shutter glasses) see both types of image. The public mode is arranged to be the luminance inverse of the private mode and therefore the non-users see an overall grey image.

US 2003/0071934 describes a dual backlight system for a liquid crystal device. The backlights are different and the purpose of having a dual backlight system is to enable a display to be switched to a mode requiring night vision goggles. The normal visible backlight is used for day-time operation and the infrared (IR) backlight for night-time operation. The angular range of the two modes is not designed to be different. U.S. Pat. No. 5,886,681 discloses a different arrangement for the same purpose.

U.S. Pat. No. 6,496,236 describes a multiple backlight system in which the backlights may be used independently. Both backlights are of the same type and the purpose of the disclosed arrangement is to enable a wide range of brightness adjustment by using one or both backlights, or alternatively to extend backlight life by using both backlights at a low illumination level.

GB 2,301,928 and WO 97/37271 describe the use of a UV (ultraviolet) or deep blue backlight for an LC (liquid crystal) display and a phosphor layer. Only one type of backlight is used, with the purpose of improving viewing angle of LC displays by using a phosphor instead of conventional colour filters, with the LCD, placed between the UV light and the phosphor, modulating the UV light.

U.S. Pat. No. 4,641,925 also describes the use of a phosphorescent layer and backlight with the purpose of providing uniform illumination to the liquid crystal display. Similarly, only one backlight type is used, though the use of a lightguide with the backlight is also considered.

GB2410116 discloses a display switchable between a public mode and a private mode. This display is shown in FIG. 3.

The display 430 has a transmissive image display device 431, which is illuminated by a first illumination system disposed behind the image display device (i.e., on the opposite side of the image display device 431 to an observer). The first illumination system comprises a first visible light source 436 directing light into a first waveguide 440. The waveguide outputs light from its upper face over a wide angular illumination range, and thereby illuminates the image display device 431.

The display 430 also comprises a second illumination system which comprises a second visible light source 434 providing visible light via a second waveguide 404 to an array of scattering centres 410. Light scattered forward from the scattering centres 410 reaches a patterned barrier layer 472, having opaque regions aligned with the scattering centres 410 and which is patterned such that light scattered by the scattering centres is passed by the barrier layer 472 only in one or more angular ranges 432. The second illumination system is disposed in front of the image display device 431, and light emitted by the second illumination system is not modulated by the image display device 431.

To obtain a private display mode, both light sources 443,436 are switched ON. Light from the second light source 434 is directed into the angular ranges 432. Thus, an observer situated in one of the angular ranges 432, such as an observer in zone 2 or in zone 3, sees light from the second light source 434 which “washes out” the image from the display device 431 in the angular ranges 432. An observer in zone 1, however, does not see light from the second light source 434 since this is blocked by the opaque regions of the barrier layer 472 and thus sees only the image from the image display device 431.

To obtain a public display mode, the first light source 436 is switched ON and the second light source is switched OFF. An image displayed on the image display device 431 is now visible to an observer in any of zones 1, 2 or 3.

For many years conventional display devices have been designed to be viewed by multiple users simultaneously. The display properties of the display device are made such that viewers can see the same good image quality from different angles with respect to the display. This is effective in applications where many users require the same information from the display—such as, for example, displays of departure information at airports and railway stations. However, there are many applications where it would be desirable for individual users to be able to see different information from the same display. For example, in a motor car the driver may wish to view satellite navigation data while a passenger may wish to view a film. These conflicting needs could be satisfied by providing two separate displays, but this would take up extra space and would increase the cost. Furthermore, if two separate displays were used in this example it would be possible for the driver to see the passenger's display if the driver moved his or her head, which would be distracting for the driver. As a further example, each player in a computer game for two or more players may wish to view the game from his or her own perspective. This is currently done by each player viewing the game on a separate display screen so that each player sees their own unique perspective on individual screens. However, providing a separate display screen for each player takes up a lot of space and is costly, and is not practical for portable games.

To solve these problems, multiple-view directional displays have been developed. One application of a multiple-view directional display is as a ‘dual-view display’, which can simultaneously display two or more different images, with each image being visible only in a specific direction—so an observer viewing the display device from one direction will see one image whereas an observer viewing the display device from another, different direction will see a different image. A display that can show different images to two or more users provides a considerable saving in space and cost compared with use of two or more separate displays.

Examples of possible applications of multiple-view directional display devices have been given above, but there are many other applications. For example, they may be used in aeroplanes where each passenger is provided with their own individual in-flight entertainment programmes. Currently each passenger is provided with an individual display device, typically in the back of the seat in the row in front. Using a multiple view directional display could provide considerable savings in cost, space and weight since it would be possible for one display to serve two or more passengers while still allowing each passenger to select their own choice of film.

A further advantage of a multiple-view directional display is the ability to preclude the users from seeing each other's views. This is desirable in applications requiring security such as banking or sales transactions, for example using an automatic teller machine (ATM), as well as in the above example of computer games.

A further application of a multiple view directional display is in producing a three-dimensional display. In normal vision, the two eyes of a human perceive views of the world from different perspectives, owing to their different location within the head. These two perspectives are then used by the brain to assess the distance to the various objects in a scene. In order to build a display which will effectively display a three dimensional image, it is necessary to re-create this situation and supply a so-called “stereoscopic pair” of images, one image to each eye of the observer.

Three dimensional displays are classified into two types depending on the method used to supply the different views to the eyes. A stereoscopic display typically displays both images of a stereoscopic image pair over a wide viewing area. Each of the views is encoded, for instance by colour, polarisation state, or time of display. The user is required to wear a filter system of glasses that separate the views and let each eye see only the view that is intended for it.

An autostereoscopic display displays a right-eye view and a left-eye view in different directions, so that each view is visible only from respective defined regions of space. The region of space in which an image is visible across the whole of the display active area is termed a “viewing window”. If the observer is situated such that their left eye is in the viewing window for the left eye view of a stereoscopic pair and their right eye is in the viewing window for the right-eye image of the pair, then a correct view will be seen by each eye of the observer and a three-dimensional image will be perceived. An autostereoscopic display requires no viewing aids to be worn by the observer.

An autostereoscopic display is similar in principle to a dual-view display. However, the two images displayed on an autostereoscopic display are the left-eye and right-eye images of a stereoscopic image pair, and so are not independent from one another. Furthermore, the two images are displayed so as to be visible to a single observer, with one image being visible to each eye of the observer.

U.S. Pat. No. 6,305,811 discloses a backlight for directs light primarily along the normal direction or along directions close to the normal direction. The backlight has a waveguide which has a light-emission surface, and protrusions are provided on the surface of the waveguide that is opposite to the light-emission surface so as to direct light out of the light-emission surface of the waveguide. The surfaces of the protrusions may have two sections having different angles of inclination.

US 2004/0264911 relates to a backlight in which the rear surface of the waveguide is profiled with prism faces so as to direct light out of the upper surface of the waveguide 18 which acts as the light emission surface. The light-emission surface of the waveguide is not flat, but is provided with ridges to concentrate output light into a narrow angular range

JP07-230002 also discloses a backlight having a waveguide, in which the light emission surface of the waveguide is profiled.

### SUMMARY OF THE INVENTION

A first aspect of the present invention provides an illumination system comprising a first waveguide and having a plurality of first light-directing surfaces provided on a first surface of the first waveguide for directing light propagating within the first waveguide into at least a first angular range while directing substantially no light into a second angular range, the first angular range being different from the second angular range; wherein the first waveguide further comprises a plurality of second light-directing surfaces provided on the first surface of the first waveguide for directing light propagating within the first waveguide into at least a third angular range while directing substantially no light into the second angular range, the third angular range being different from the first angular range and the second angular range, and the third angular range being on the opposite side of the second angular range to the first angular range; wherein a first light directing surface of the first waveguide comprises at least a first portion having a first angle of inclination relative to the normal axis to the first waveguide and a second portion having a second angle of inclination relative to the normal axis to the first waveguide, the second angle of inclination being different from the first angle of inclination, the first and second angles of inclination being on the same side of the normal axis as one another; and wherein a second light directing surface of the first waveguide comprises at least a portion having a third angle of inclination relative to the normal axis to the first waveguide and a portion having a fourth angle of inclination relative to the normal axis to the first waveguide, the third angle of inclination being different from the fourth angle of inclination, and the third and fourth angles of inclination being on the same side of the normal axis as one another.

In the display 430 of FIG. 3, the scattering structure comprises prisms disposed on the rear face of the second waveguide 404. The prisms have a generally triangular cross-section, as shown in FIG. 4(a) which is a partial sectional view through the second waveguide 404. FIG. 4(a) shows one prism 406, having a first planar light-directing surface 408 for directing light into zone 2 and a second planar light-directing surface 416 for directing light into zone 3. As is well-known, the waveguide 404 has a higher refractive index than material adjacent to the upper face or lower face of the waveguide, so that light propagating within the waveguide is confined within the waveguide by total internal reflection at the upper and lower faces of the waveguide. However, light that is reflected by one of the light-directing surfaces 408,416 is incident on the upper face of the waveguide 404 at an angle to the normal axis that is less than the critical angle for total internal reflection and so is emitted from the waveguide as shown in FIG. 4(a). The angular spread of light emitted from the waveguide is dependent on, among other factors, the characteristics of the barrier layer 472 and the angle of inclination of the light directing surface 408,416. FIG. 4(b) is a schematic illustration of the resultant intensity (in arbitrary units) against viewing angle, and shows that the planar light-directing surfaces 408,416 of FIG. 4(a) lead to a waveguide that emits light in the angular range of from approximately 20° to 65° (and, if the prism 406 is symmetric, also in the angular range of approximately −20° to −65°). (These angles, and angles defined below, are measured with respect to the axis normal (i.e., perpendicular) to the display face of the display, herein after referred to as the normal axis of the display.)

The display of FIG. 3 therefore has the disadvantage that it cannot provide a good private mode. This is because, when the second light source 434 is switched ON to put the display in the private mode, light from the second light source is directed only into zone 2 and zone 3, which, as explained above, extend from approximately −20° to −65° and from approximately 20° to 65°. As a result, an observer located in zone 4 or in zone 5 does not see any light from the second light source 434, although they are likely to see an image displayed by the image display layer 431. The private mode is therefore not effective at obscuring an image from anyone but the intended viewer.

FIGS. 4(c) to 4(f) show the effect of varying the angle of inclination of the light-directing faces 408,416 of the prism 406. FIGS. 4(c) and 4(e) show a cross-section through the waveguide 404 for two different barrier layer characteristics and angles of inclination of the light-directing faces 408,416, with each angle of inclination being different from the angle of inclination of FIG. 4(a), and FIGS. 4(d) and 4(f) show the corresponding distributions of intensity against viewing angle. As FIGS. 4(d) and 4(f) show, while it is possible to change the angular position of zone 2 and zone 3 by varying the barrier layer characteristics and the angle of inclination, the angular extent of zone 2 and zone 3 remains at about 45°. Thus, in FIG. 4(d) zone 2 and zone 3 extend from approximately 30° to 75° and from −30° to −75°, and in FIG. 4(F) zone 2 and zone 3 extend from approximately 45° to 90° and from −45° to −90°. Neither case provides an effective private mode. In the case of FIGS. 4(e) and 4(f), for example, the central viewing zone in which a displayed image is visible in the private mode would extend from −45° to 45°, but this is far too wide to provide effective privacy. It is desirable that, in the private mode, a displayed image is visible in a viewing zone that extends from approximately −20° to 20° and is not visible at any other viewing angles.

In an illumination system of the present invention, the light directing surface of the waveguide comprises at least a first portion having a first angle of inclination relative to the normal axis and a second portion having a second, different angle of inclination. The first and second portions direct light into different angular ranges. Thus, when the illumination system is used as the second illumination system of a display having the general structure of FIG. 3, the resultant zones 2 and 3 will have a larger angular extent than the zones 2 and 3 of the display of FIG. 3. Thus, a more effective private mode can be obtained.

The first portion and the second portion of the first light-directing surface may be planar.

A first light directing surface of the first waveguide may be non-planar.

A first light-directing surface may be arranged such that the first angular range subtends an angle of approximately 70° or greater.

The third and fourth angles of inclination may be on the opposite side of the normal axis to the first and second angles of illumination.

The first portion and the second portion of the second light-directing surface may be planar.

A second light directing surface of the first waveguide may be non-planar.

A second light-directing surface may be arranged such that the first angular range subtends an angle of approximately 70° or greater.

The spacing between neighbouring first light-directing surfaces may vary with distance from a side edge of the first waveguide.

The light-directing surfaces may be arranged in pairs, with each pair including one first light-directing surface and one second light-directing surface.

The ratio between the number of first light-directing surfaces and the number of second light-directing surfaces may vary with distance from a side edge of the first waveguide.

The illumination system may further comprise an optical compensation plate disposed adjacent to the first surface of the first waveguide, and having a surface complementary in shape to the shape of the first surface of the first waveguide.

Alternatively, the illumination system may further comprise birefringent material disposed over the first surface of the first waveguide.

The illumination system may further comprise a second waveguide arranged to direct light propagating in the second waveguide into a fourth angular range, the fourth angular range being generally opposite to the first, second and third angular ranges.

The second waveguide may comprise a surface shaped so as direct light propagating in the second waveguide into the fourth angular range.

The shaped surface of the second waveguide may be generally complementary in shape to the first surface of the first waveguide.

A plurality of concave structures may be provided in the shaped surface of the second waveguide.

The illumination system may further comprise a second waveguide arranged to direct light propagating in the second waveguide into the second angular range.

The second waveguide may comprise a surface shaped so as direct light propagating in the second waveguide into the second angular range.

The shaped surface of the second waveguide may be generally complementary in shape to the first surface of the first waveguide.

The second waveguide may comprise a scattering structure for scattering light propagating in the second waveguide into the second angular range.

A second aspect of the invention provides a display comprising: an image display device; and an illumination system of the first aspect disposed between the image display device and an intended viewing position of the display.

The image display device may be a reflective image display device.

A substrate of the image display device may constitute the second waveguide of the illumination system.

A third aspect of the invention provides a display comprising: an image display layer; and an illumination system of the invention, the image display layer being disposed between the illumination system and an intended viewing position of the display.

The present invention also provides an illumination system comprising a first waveguide and having a plurality of first light-directing surfaces provided on a first surface of the first waveguide for directing light propagating within the first waveguide into at least a first angular range while directing substantially no light into a second angular range, the first angular range being different from the second angular range; wherein a first light directing surface of the first waveguide comprises at least a first portion having a first angle of inclination relative to the normal axis to the first waveguide and a second portion having a second angle of inclination relative to the normal axis to the first waveguide, the second angle of inclination being different from the first angle of inclination, the first and second angles of inclination being on the same side of the normal axis as one another.

### BRIEF DESCRIPTION OF THE DRAWINGS

Preferred embodiments of the present invention will now be described by way of illustrative examples, with reference to the accompanying figures in which:

FIG. 1 is a schematic sectional view of a transmissive display;

FIG. 2 is a schematic illustration of a display having a private mode of operation;

FIG. 3 is a schematic sectional view of a display switchable between a private mode of operation and a public mode of operation;

FIG. 4(a) illustrates one possible cross-section for a light-directing protrusion of the display of FIG. 3, and FIG. 4(b) illustrates the corresponding angular distribution of intensity;

FIG. 4(c) illustrates another possible cross-section for a light-directing protrusion of the display of FIG. 3, and FIG. 4(d) illustrates the corresponding angular distribution of intensity;

FIG. 4(e) illustrates one possible cross-section for a light-directing protrusion of the display of FIG. 3, and FIG. 4(f) illustrates the corresponding angular distribution of intensity;

FIG. 5(a) illustrates one possible cross-section for a light-directing protrusion of an embodiment of the present invention;

FIG. 5(b) is a partial enlarged view of FIG. 5(a); and

FIG. 5(c) illustrates the angular distribution of intensity provided by a light-directing protrusion having the cross-section shown in FIG. 5(a);

FIGS. 6(a) and 6(b) show an illumination system according to an embodiment of the present invention;

FIG. 7(a) is a partial view of an illumination system according to a further embodiment of the present invention;

FIG. 7(b) is a partial enlarged view of the illumination system of FIG. 7(a);

FIG. 8 is a schematic sectional view of an illumination system according to a further embodiment of the present invention.

FIG. 9(a) is a schematic sectional view of an illumination system according to a further embodiment of the present invention;

FIGS. 9(b), 9(c) and 9(d) are partial enlarged views of the illumination system of FIG. 9(a);

FIG. 10(a) is a schematic sectional view of an illumination system according to a further embodiment of the present invention;

FIG. 10(b) is a schematic sectional view of an illumination system according to a further embodiment of the present invention;

FIG. 10(c) illustrates the illumination system of FIG. 10(b) in use;

FIG. 10(d) is a schematic sectional view of an illumination system according to a further embodiment of the present invention;

FIG. 11(a) is a schematic sectional view of an illumination system according to a further embodiment of the present invention;

FIGS. 11(b) and 11(c) illustrate operation of the illumination system of FIG. 11(a);

FIGS. 12(a) and 12(b) are schematic sectional views of an illumination system according to a further embodiment of the present invention incorporated in a reflective display;

FIGS. 13(a) and 13(b) are schematic sectional views of an illumination system according to a further embodiment of the present invention incorporated in a reflective display; and

FIG. 14 is a schematic sectional view of an illumination system according to a further embodiment of the present invention incorporated in a display.

### DESCRIPTION OF THE EMBODIMENTS

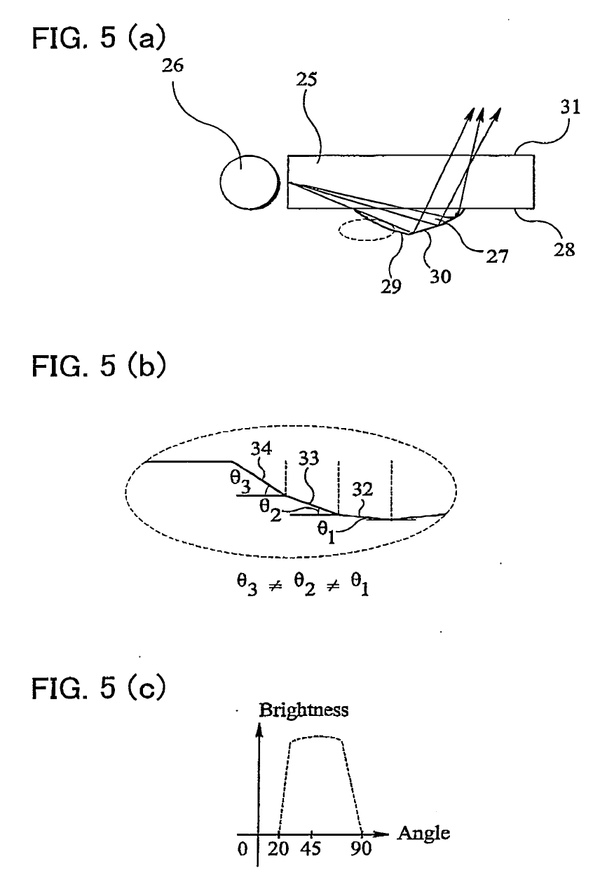

FIG. 5(a) is a schematic illustration of an illumination system according to an embodiment of the present invention. The illumination system comprises a waveguide 25 and one or more light sources 26. One light source 26 is shown in FIG. 5(a), but the invention is not limited to this.

Protrusions 27 are provided on a first surface 28 of the waveguide 28. As is explained above, light propagating within the waveguide is reflected by light-directing surfaces 29, 30 of the protrusion 27, and passes out of the surface 31 of the waveguide opposite to the surface 28 on which the protrusions 27 are provided.

The light-directing surfaces 29 direct light into a first angular range while directing substantially no light into a second angular range, the first angular range being different from the second angular range. The light directing surfaces 30 direct light into a third angular range while directing substantially no light into the second angular range. The third angular range is different from the first angular range and the second angular range, and the third angular range is on the opposite side of the second angular range to the first angular range. Preferably, the light-directing surfaces 29 direct light into an angular range on one side of the normal axis to the front face 31 of the waveguide 25, the light-directing surfaces 30 direct light into an angular range on the other side of the normal axis to the front face 31 of the waveguide 25, and little or no light is directed into an angular range centred about the normal axis.

According to the present invention, the light-directing surfaces 29, 30 of the protrusion 27 are not planar as in FIG. 5(a). Instead, a light-directing surface of the protrusion 27 comprises at least a first portion having a first angle of inclination and a second portion having a second, different angle of inclination. This is shown in FIG. 5(b), which is an enlarged view of a light-directing surface 29 of the protrusion 27. As can be seen, the light-directing surface comprises three portions 32-34, each having a different angle of inclination to the plane of the waveguide 25. In this embodiment each of the portions 32, 33, 44 of the light-directing surface 29 is planar and typical values for the angles of inclination are θ₁=15°, θ₂=20° and θ₃=25°.

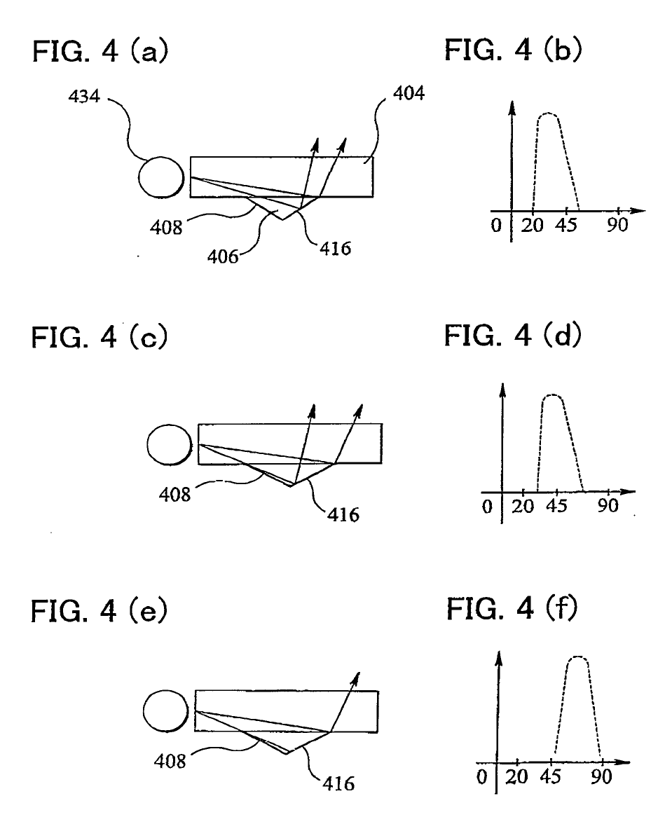

Since the portions 32, 33, 34 of the light-directing surface 29 have different angles of inclination, they reflect light into different angular ranges. As a result, the light-directing surface 29 reflects light into a greater angular range than does the planar light-directing surface of FIG. 4(a). As is shown in FIG. 5(c), by suitable choice of the angles of inclination of the portions 32, 33, 34 of the light-directing surfaces, it is possible to produce a light-directing surface that directs light into an angular range of from approximately 20° to approximately 90°.

In this embodiment, the second light-directing surface 30 is a mirror image of the first light-directing surface 29, and so directs light into an angular range of from approximately −90° to approximately −20°.

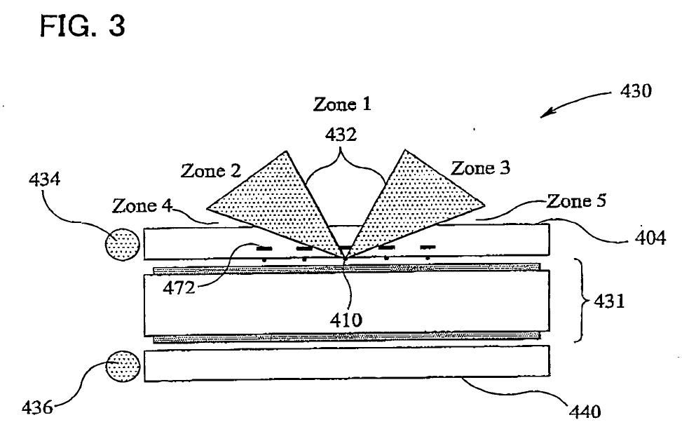

When an illumination according to the present invention is used as the second illumination system in a display such as shown in FIG. 3, when the light source(s) of the second illumination system is/are switched on, the second illumination system directs light into angular ranges 432 that extend from approximately −90° to −20°, and from approximately 20° to approximately 90°. An image displayed on the image display device 31 is therefore visible only to an observer in a zone (zone 1) extending from approximately −20° to 20°. The display therefore has a good private mode.

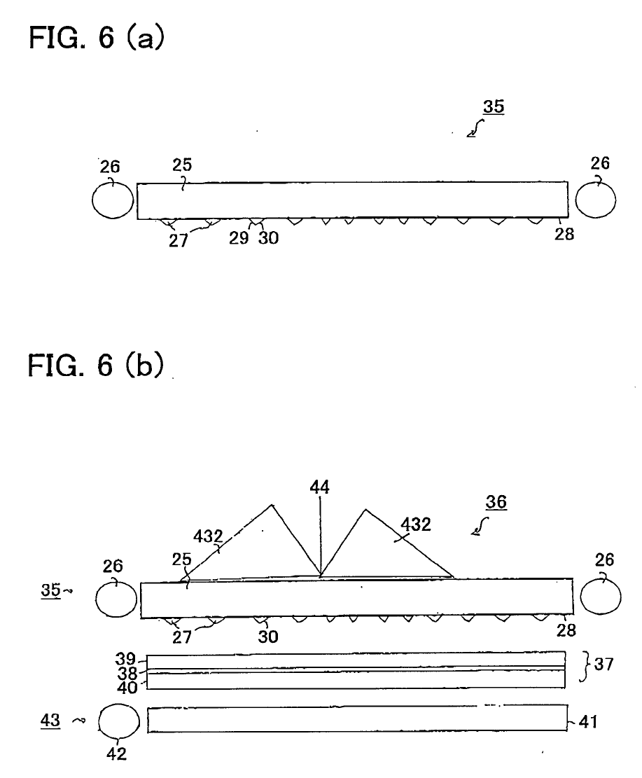

FIG. 6(a) is a schematic illustration of an illumination system 35 according to the present invention. The illumination system comprises, as indicated in FIG. 6(a), a waveguide 25 and one or more light sources 26. In the illumination system 35, two light sources 26 are shown, arranged along opposite side edge faces of the waveguide 25. However, the invention is not limited to this and one light source or more than two light sources may in principle be used. The or each light source 26 may be, for example, a miniature fluorescent tube or a cold cathode fluorescent light source.

A plurality of protrusions 27 are provided on a first surface 28 of the waveguide. As explained with reference to FIG. 5(a) above, the light-directing surfaces 29, 30 of each protrusion are not planar, but comprise at least a first portion having a first angle of inclination and a second portion having a second, different angle of inclination. For example, each light-directing surface 29, 30 may comprise first, second and third portions 32-34 each having a different angle of inclination relative to the plane of the waveguide, as shown in FIG. 5(b).

FIG. 6(b) shows the illumination system 35 of FIG. 6(a) incorporated in a display 36. The display 36 comprises an image display device 37, shown as comprising an image display layer 38 disposed between first and second substrates 39, 40. The image display layer may be, for example, a liquid crystal layer, and the display device 37 may be a pixellated display device.

FIG. 6(b) shows a display in which the image display device 37 is a transmissive display device. The display 36 therefore comprises a first illumination system 43 for illuminating the image display device 37 from behind. FIG. 6(b) shows the first illumination system 43 as comprising a waveguide 41 and one or more light sources 42, but any suitable backlight may be used as the first illumination system. The first illumination system 43 preferably emits light with substantially uniform intensity over a wide angular range.

The illumination system 35 of FIG. 6(a) is disposed in front of the image display device 37, between the image display device 37 and the intended position of an observer. When the or each light source 26 of the second illumination system 35 is switched OFF, and the first illumination system 43 is switched ON, an image displayed on the image display device 37 can be viewed over a wide angular range, and the display operates in a public mode.

When the or each light source 26 of the second illumination system is switched ON, and the first illumination system 43 is also switched ON, the display 36 operates in a private display mode. As explained above, the second illumination system 35 directs light into one or more angular ranges 432, and an observer positioned within such an angular range 432 is unable to perceive an image displayed on the image display device 37, since the image is “washed-out” by light from the second illumination system. Preferably, the second illumination system 35 directs light into two angular ranges 432 that are substantially symmetric about the normal axis of the display 36, and that particularly preferably extend from −90° to approximately −20° from the normal axis, and from approximately 20° to 90° from the normal axis.

In the illumination system of FIG. 6(a), the protrusions 27 may be integral with the waveguide 28. For example, the waveguide with protrusions 27 may be formed by a moulding process. Alternatively, the protrusions 27 may be separate components from the waveguide 25. For example, the protrusion 27 may be formed by depositing a layer of photoresist or transparent resin over a waveguide 25, and then patterning the layer of photoresist or resin to form the protrusions 27. As a further alternative, the protrusions 27 may be formed by laser ablation.

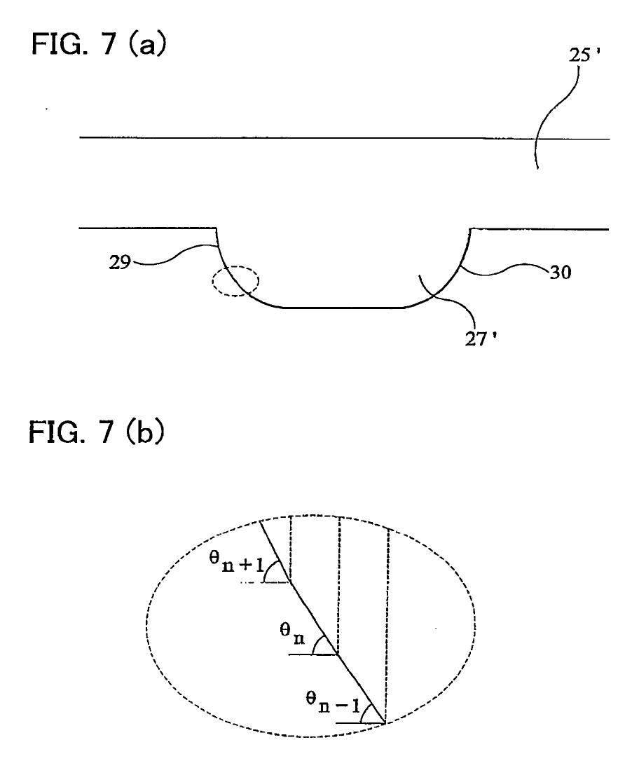

In the embodiment of FIG. 5(a), the light-directing surfaces of the protrusions 27 are formed of a plurality of planar sections 32-34. The invention is not, however, limited to this. FIG. 7(a) is a schematic sectional view through a waveguide 25′ suitable for use in an illumination system of a further embodiment of the present invention.

In the embodiment of FIG. 7(a), each light-directing surface 29, 30 of a protrusion 27′ is formed of a large number of portions, with each portion having an angle of inclination that is slightly different from the angle of inclination of a neighbouring portion. As a result, the overall shape of the light-directing surface 29, 30 approximates a curved surface as shown in FIG. 7(a).

FIG. 7(b) is an enlarged partial view of a light-directing surface 29 of the protrusion 27′ of FIG. 7(a). As can be seen, one portion 33 of the light-directing surface is inclined at an angle θₙ which is slightly greater than the angle of inclination θₙ₋₁ of one adjacent portion 32, and is slightly less than the angle of inclination θₙ₊₁ of the other neighbouring portion 34.

As an alternative to the discrete planar portions 32-34, a continuously curved profile may be formed so as to provide the desired angular ranges. As a further alternative, such a curved profile may be approximated by a suitable member of planar portions and this may be easier to manufacture, for example with fewer manufacturing defects.

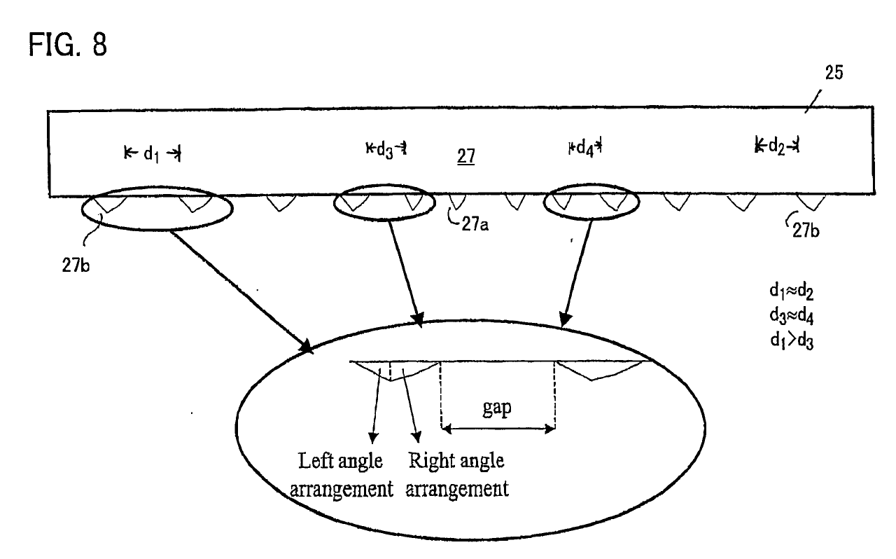

In the embodiments of FIGS. 6(a) and 7(a), the protrusions 27, 27′ have the form of prisms that extend into the plane of the paper. In principle the spacing between adjacent protrusions could be uniform over the area of the waveguide, but, in practice, it may be desirable for the spacing between adjacent protrusions to vary with a distance from a light source 26. This is because the intensity of light propagating within the waveguide 25 decreases as the distance away from a light source 26 increases, owing to the extraction of light from the waveguide. In order to compensate for this decrease in intensity of light within the waveguide, it is preferable if the spacing between adjacent protrusions decreases as the distance away from the light source 26 increases. This effect is illustrated in FIG. 8—near the light sources 26, the spacing d between adjacent protrusions is relatively large, and decreases with increasing distance away from a light source. FIG. 8 shows a waveguide intended for use with two light sources, arranged adjacent to opposing edge faces of the waveguide as shown in FIG. 6(a), so that the spacing between adjacent protrusions reaches a minimum in the centre of the waveguide. Thus, the spacing between adjacent protrusions at one edge of the waveguide, d₁ is approximately equal to the spacing between adjacent protrusions d₂ near the edge face where the second light source is disposed. The spacing between adjacent protrusions decreases moving away from either light source, and reaches a minimum spacing d₃, d₄ at the centre of the waveguide.

Additionally or alternatively, the cross-section shape of the protrusions may vary with distance away from a light source. For example, while a symmetric cross-section, as for the protrusion 27 as shown in FIG. 5(a), may be appropriate for a protrusion 27a substantially midway across the waveguide 25, a protrusion 27b or 27c near an edge of the waveguide would preferably have an asymmetric cross-section. Such an arrangement may be used to provide a more constant angular output range across the waveguide.

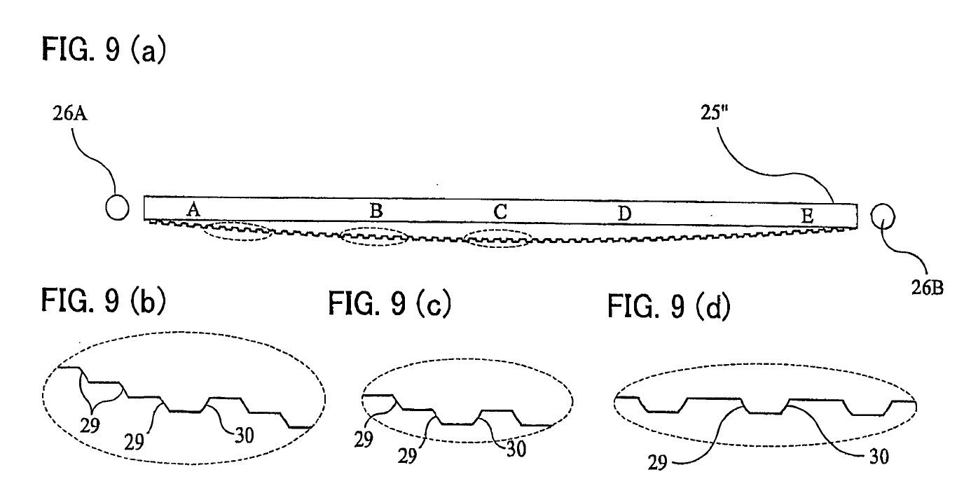

FIG. 9(a) shows a waveguide 25″ suitable for use in a further illumination system of the present invention. The illumination system again has a plurality of light-guiding surfaces 29, 30 provided on its lower surface. Each light-guiding surface 29, 30 comprises two or more portions having different angles of inclination.

In this embodiment, the light-directing surfaces 29, 30 are notionally arranged in groups, with each group comprising one or more light-directing surfaces 29 for directing light into one angular range and one or more light-directing surfaces 30 for directing light into a second angular range. The light-directing surfaces 29 will be referred to as “left light-directing surfaces” and the light-directing surfaces 30 will be referred to as “right light-directing surfaces”, since they reflect light into an angular range to the left/right of the normal axis of the waveguide.

In this embodiment, the ratio between the number of right light-directing surfaces in a group to the number of left light-directing surfaces in a group varies with distance from the edge of the waveguide. This is to compensate for the variation in the ratio between the intensity of light propagating to the left within the waveguide and the intensity of light propagating to the right within the waveguide.

FIG. 9(a) shows a waveguide that is illuminated by two light sources 26A,26B. One light source 26A is adjacent to a left edge face of the waveguide, and the other light source 26B is adjacent to a right edge face of the waveguide. As an example, in region A of the waveguide, light propagating to the right will have a high intensity since region A is close to the first light source 26A. Light propagating to the left will, however, have a low intensity in region A, since light propagating to the left has come from the second light source 26B, which is on the opposite side of the waveguide to region A—the decrease in intensity is owing to the extraction of light emanating from the second light source 26B from the waveguide before it reaches region A.

In region A, therefore, the ratio between the number of left light-directing surfaces 29 (which direct light from the second light source 26B) to the number of right light-directing surfaces 30 (which direct light from the first light source 26A) is therefore made high, to compensate for the low intensity of light from the second light source 26B compared to the intensity of light from the first light source 26A in region A. For example, as is shown in FIG. 9(b), three left light-directing surfaces 29 may be provided for every one right light-directing surface 30 in region A.

In the centre of the waveguide, in region C, light from the first light source 26A will have approximately the same intensity as light from the second light-source 26B, as region 26C is substantially equidistant from the two light sources. Accordingly, in region C there is preferably one left light-directing surface 29 for every right light-directing surface 30, as shown in FIG. 9(d).

Region B of the waveguide 25″ is between region A and region C. Light from the second light source 26B will therefore have a lower intensity than light from the first light source 26A in region B, but the different in intensities of the two light sources will be less than in region A. In region B, therefore, two left light-directing surfaces 29 are provided for each one right light-directing surface 30, as shown in FIG. 9(c).

In the embodiment of FIG. 9(a), the shape of the individual left and right light-directing surfaces 29, 30 may vary with position across the waveguide, as described with reference to FIG. 8, so as to maintain a constant angular distribution of light over the area of the waveguide 25″. Additionally or alternatively, the separation between neighbouring right light-directing surfaces may be varied over the regions A, B and C to compensate for the decrease in intensity of right-going light as the distance from the first light source increases.

FIG. 9(a) shows a waveguide 25″ intended to be illuminated by two light sources 26A, 26B arranged along opposing edge faces of the waveguide. The waveguide 25″ is therefore preferably symmetrical about its centre. Thus, in region E, for example, there would be three right light-directing faces 30 for every one left light-directing face 29, and in region D there would be two right light-directing faces 30 for every one left light-directing face 29.

The waveguide 25″ of FIG. 9(a) may be manufactured by, for example, a moulding process in which the waveguide 25 and light-directing faces 29, 30 are moulded as one integral structure. Alternatively, the waveguide may be coated with a layer which is then processed, for example by moulding, lithography or laser ablation to provide the light-directing faces.

Where an illumination system of the present invention is used as a front illumination system for a display, for example as in the display of FIG. 6(b), an observer will see the image displayed on the image display device 37 through the waveguide of the illumination system. It is possible that the provision of the light-directing surfaces 29, 30 on the lower surface of the waveguide may cause distortion of the image. This distortion can occur when the display of FIG. 6(b) is in its wide display mode with the illumination system 35 switched OFF or in its narrow display mode with the illumination system 35 switched ON. To prevent this distortion from occurring, it is preferable to provide an image compensation layer 45 in the path of light from the display device to an observer.

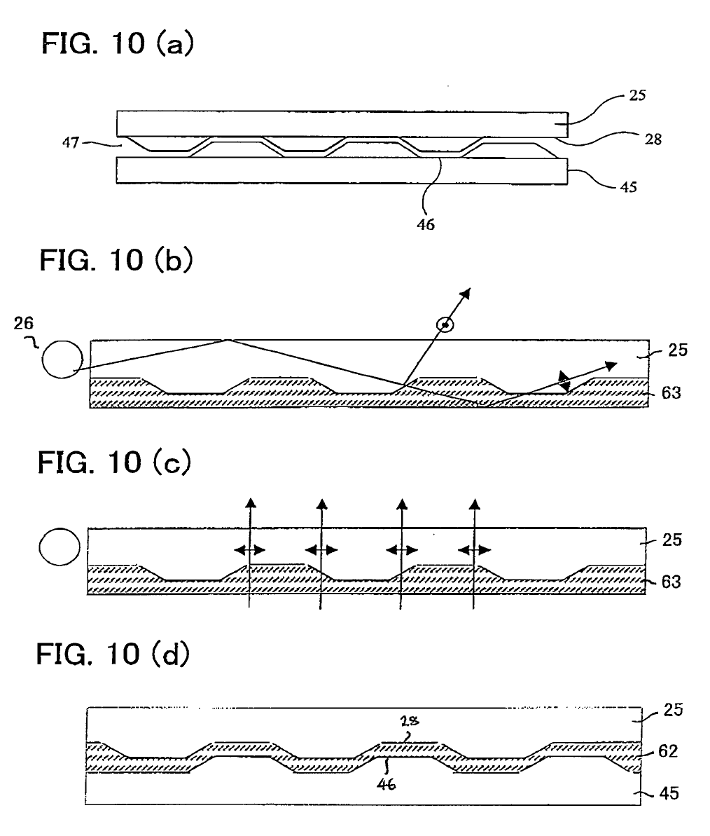

An optical compensation layer 45 that is suitable for use with a waveguide 25 having the general structure shown in FIG. 6(a) is shown in FIG. 10(a). A surface 46 of the optical compensation layer that is intended to be disposed adjacent to the lower face 28 of the waveguide has a shape that is generally complementary to the shape of the lower face 28 of the waveguide. Thus, if the optical compensation layer was abutted directly against the waveguide the result would be a regular rectangular substrate. The optical compensation layer 45 has a refractive index that is equal to, or close to, the refractive index of the waveguide 25.

In use, the optical compensation layer 45 is disposed adjacent to the lower face 28 of the waveguide, with a small gap 47 therebetween. The gap 47 may be an air gap as shown in FIG. 10(a), or it may be filled with a material 62 having a lower refractive index than the refractive index of the waveguide 25 as shown in FIG. 10(d). (It is necessary that the gap 47 has a lower refractive index than the waveguide 25, to ensure that total internal reflection occurs at the light-directing surfaces 29, 30 of the waveguide.) As an example, the optical compensation layer 45 may be adhered to the waveguide using a transparent adhesive that has a refractive index lower than the refractive index of the waveguide 25. Since the upper surface of the optical compensation layer 45 has a shape that is complementary to the shape of the lower face 28 of the waveguide, little or no overall distortion occurs when light passes through the combination of the optical compensation layer 45 and the waveguide 25. An observer viewing the display thus sees an image displayed on the display layer of the display with little or no distortion.

Providing a material 62 having a lower refractive index than the refractive index of the waveguide 25 in the gap 47 between the optical compensation layer 45 and the waveguide 25, as in FIG. 10(d), increases the physical strength of the illumination system. The presence of the air gap in FIG. 10(a) means that that the illumination system of FIG. 10(a) is liable to deform, and possibly even break, if a force is applied.

The embodiments of FIGS. 10(a) and 10(d) require that the upper surface 46 of the optical compensation layer 45 is generally complementary to the shape of the lower face 28 of the waveguide 25, and it may be difficult and time-consuming to manufacture the optical compensation layer 45 with its upper surface to the required shape. Moreover, the optical compensation layer 45 must be correctly aligned with the waveguide 25, and it can again be difficult to align the optical compensation layer 45 and the waveguide. In an alternative embodiment, therefore, the lower face of the waveguide 25 is planarised with a birefringent material such as, for example, a reactive mesogen. This embodiment is illustrated in FIGS. 10(b) and 10(c), which shows a layer of a birefringent material 63 disposed over the lower surface 28 of the waveguide 25 so as to planarise the lower surface. The lower surface 64 of the layer of birefringent material 63 is substantially planar, and is preferably parallel to the upper surface of the waveguide 25. The birefringent material 63 is selected such that the refractive index of the waveguide 25 is equal to, or is substantially equal to, one of the refractive indices of the birefringent material. For example, the refractive index of the waveguide 25 may be equal to, or substantially equal to, the extraordinary refractive index nₑ of the birefringent material 63.

This embodiment is suitable for use in a case where the underlying image display device (the image display device 37 of FIG. 6(b), for example), emits polarised light—as will be the case where the underlying image display device is a liquid crystal image display device. The birefringent material is selected such that, for polarised light emitted by the display, the refractive index of the waveguide 25 is equal to, or is substantially equal to, the refractive index of the birefringent material. Thus, light from the display experiences little or no change in refractive index at the interface between the birefringent material 63 and the waveguide 25, and is therefore not significantly refracted at the interface between the birefringent material 63 and the waveguide 25 as shown in FIG. 10(c). An image displayed on the image display device is therefore visible to an observer with little or no distortion.

The light source 26 emits unpolarised light, and this can be considered as containing two orthogonal polarisations. One of these polarisations will not experience a change in refractive index at the interface between the birefringent material 63 and the waveguide 25, and is therefore not refracted at the interface between the birefringent material 63 and the waveguide 25. In FIG. 10(b) and 10(c) it is assumed that the refractive index of the birefringent material 63 for light that is plane polarised in the plane of the paper, denoted by the doubleheaded arrow symbol, is equal to, or is substantially equal to the refractive index of the waveguide—light of this polarisation is therefore trapped within the composite waveguide defined by the waveguide 25 and the birefringent material 63. (Light from the display is also assumed to be of this polarisation, as denoted by the doubleheaded arrow symbol in figure 10(c).)

Light from the light source 26 that is plane polarised perpendicular to the plane of the paper, denoted by the ⊚ symbol in FIG. 10(b), will experience a change in refractive index at the interface between the birefringent material 63 and the waveguide 25 since, for light of this polarisation, the refractive index of the birefringent material 63 is not equal to the refractive index of the waveguide 25. Light of this polarisation thus undergoes internal reflection at the interface between the birefringent material 63 and the waveguide 25, and is directed by the light-directing surfaces of the waveguide 25 in the manner described above.

As illustrated in FIG. 10(b), light of one polarisation is trapped within the composite waveguide defined by the waveguide 25 and the birefringent material 63. This polarization may be recycled, for example by providing a depolarizing mirror at one side of the waveguide 25. Alternatively, this polarization may be eliminated by using a polarised light source for the light source 26.

This embodiment may be used with an underlying image display device that emits unpolarised light, by providing a polariser between the image display device and the birefringent material.

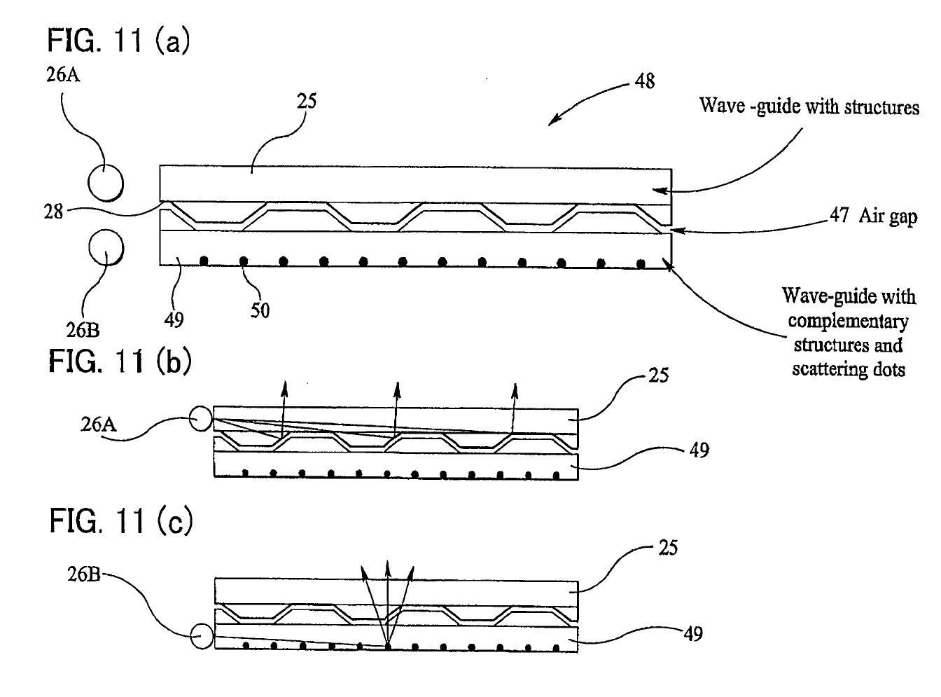

FIG. 11(a) shows an illumination system according to a further embodiment of the present invention. The illumination system 48 comprises a first waveguide 25 that is illuminated in use by one or more first light sources 26A. Only one first light source 26A is shown in FIG. 11(a), but the invention is not limited to this.

The waveguide 25 is a waveguide of the invention as described above, for example with reference to any one of FIGS. 6(a), 7(a), 8 or 9(a). The waveguide comprises light-directing surfaces 29, 30 that have at least first and second portions having different angles of inclination. The light-directing surfaces are arranged such that when the or each first light source 26A is illuminated, the waveguide 25 directs light from the or each first light source into two or more angular ranges 432, as shown in FIG. 6(b).

The illumination system 48 of FIG. 11(a) further comprises a second waveguide 49. The upper surface 51 of the second waveguide 49 has a shape that is complementary to the shape of the lower surface 28 of the first waveguide 25 Thus, if the first and second waveguides were abutted directly together, they would form a regular parallelepiped.

In use, the first and second waveguides are positioned with a gap 47 between them, the gap 47 may be an air gap, or it may be filled with a material having a lower refractive index than the refractive indeed of the waveguide 25 such as, for example, a low refractive index transparent adhesive (the refractive index of the adhesive must be lower than the refractive index of the waveguide so that internal reflection occurs).

The second waveguide 49 is provided with scattering structures 50, for example in the form of scattering dots as used in conventional display backlights. The second waveguide is illuminated by one or more second light sources 26B that, when switched ON, direct light into the interior of the second waveguide 49. One second light source 26B is shown in FIG. 11(a), but the invention is not limited to the use of only one second light source. The or each second light source may be, for example, a fluorescent tube arranged along an edge of the waveguide.

When the or each second light source 26B is switched ON, light is scattered out of the shaped surface 51 of the second waveguide 49 by the scattering structures 50. The scattering structures are arranged so as to extract light from the second waveguide over a wide angular range, as shown in FIG. 11(c). Preferably, the scattering structures 50 are arranged so that light is extracted from the second waveguide with relatively uniform intensity over a wide angular range.

When the or each of the first light source 26A is illuminated, the first waveguide 25 directs light into two or more angular ranges 432, as shown in FIG. 11(b).

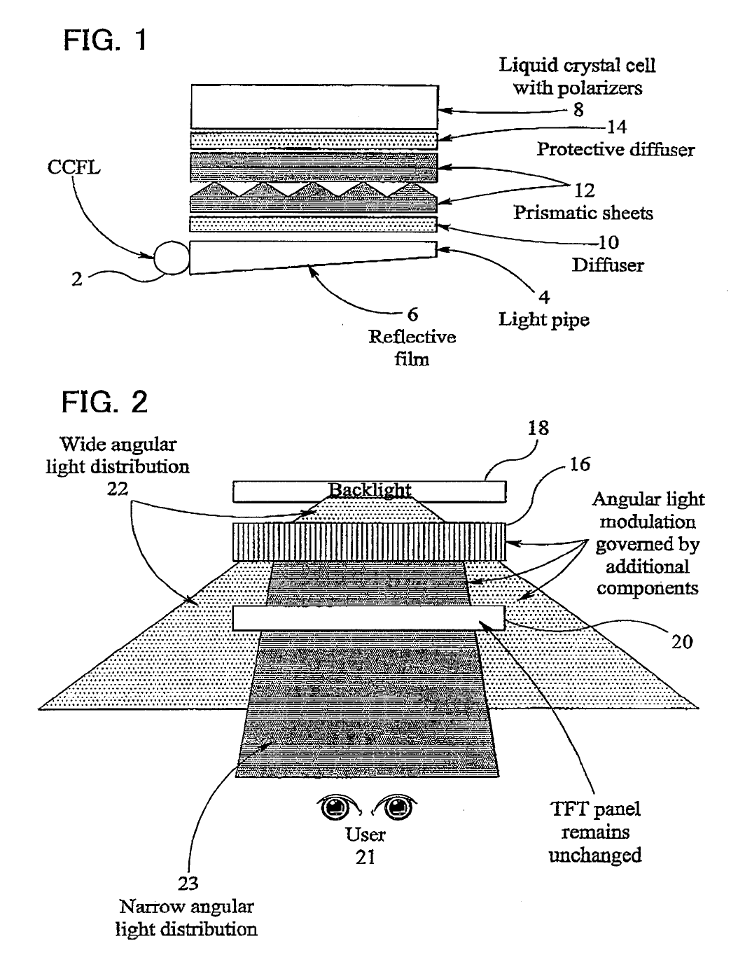

The illumination system 48 of FIG. 11(a) may be used as a backlight in a display having a transmissive image display device. For example, the illumination system 48 could be used as the backlight for the liquid crystal cell of a transmissive display shown in FIG. 1 of the present application. Use of the illumination system 48 in a display provides a display that can be switched between a conventional 2-D display mode and a directional display mode. When the or each second light source 26B is switched ON, and the or each first light source 26A is switched OFF, the illumination system emits light over a wide angular range, and a 2-D display mode is obtained. When the or each first light source 26A is switched ON and the or each second light source 26B is switched OFF, the illumination system emits light into two or more angular ranges 432, thereby providing a directional display mode, such as a dual view display mode or a 3-D autostereoscopic display mode.

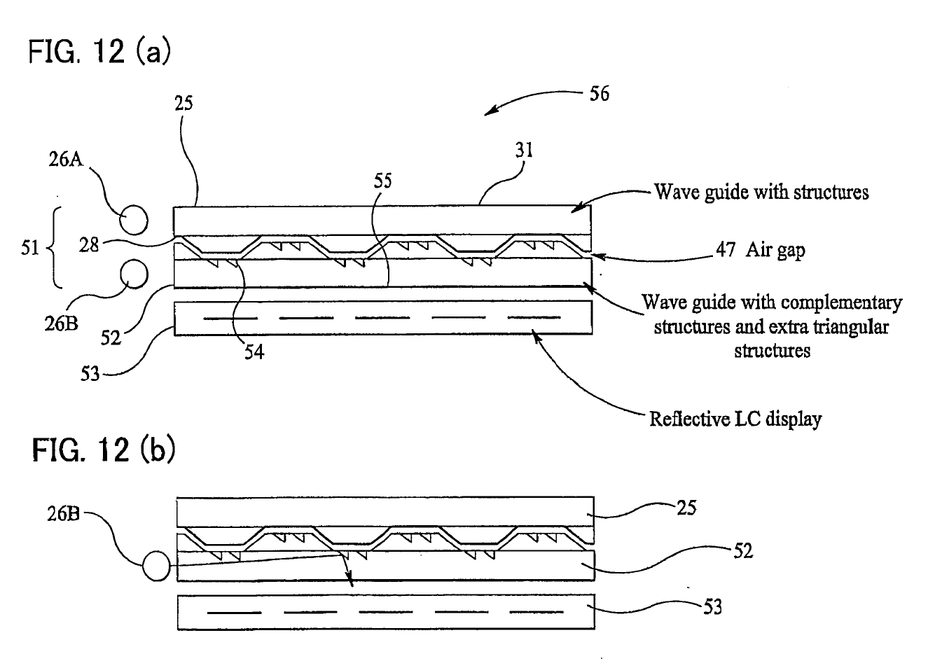

FIG. 12(a) shows a further illumination system 51 of the present invention. The illumination system 51 comprises a first waveguide 25 of the invention as described above, which may be, for example, a waveguide as described in any of FIGS. 6(a), 7(a), 8 or 9(a). The waveguide comprises light-directing surfaces 29, 30 that have at least first and second portions having different angles of inclination. Further description of the first waveguide 25 will not be repeated here. The first waveguide is illuminated by one or more first light sources 26A which may be, for example, a fluorescent tube arranged along an edge of the waveguide.

The illumination system 51 further comprises a second waveguide 52. The upper surface of the second waveguide 52 has a shape that is generally complementary to the shape of the lower face 28 of the first waveguide, so that, if the first and second waveguides were abutted together a regular parallelepiped would be obtained.

In use, the first waveguide is spaced from the second waveguide by a gap 47, which may be an air gap or which may be filled with a low refractive index material.

The second waveguide is provided with one or more second light sources 26B. Only one second light source is shown in FIG. 12(a), but the invention is not limited to the use of just one second light source. When the or each second light source is illuminated, light is introduced into the second waveguide 52.

The second waveguide 52 is further provided with scattering structures 54 for extracting light from the second waveguide 52. Whereas the first waveguide 25 is arranged such that light propagating within the first waveguide is extracted from the upper face 31 of the first waveguide, the second waveguide is arranged such that light propagating within the waveguide is extracted from the lower face 55 of the second waveguide. Thus, light is extracted from the second waveguide into an angular range which is generally in an opposite direction to the direction of the angular range in which light is extracted from the first waveguide 25.

The illumination system 51 of FIG. 12(a) is shown incorporated in a display 56 having a reflective image display device 53 such as a reflective liquid crystal display device. The illumination system 51 is disposed between the reflective display device 53 and the intended position of an observer.

The display 56 incorporating the illumination system 51 of the present invention is switchable between a wide display mode and a narrow display mode. FIG. 12(b) illustrates the display 56 in its wide display mode. In this mode, the or each second light source 26B is switched ON, and the or each first light source 26A is switched OFF. Light is extracted from the second waveguide 52 through its lower face 55, and illuminates the reflective display device 53. The second waveguide is arranged to illuminate the reflective display device with light having a wide angular spread, so that an image displayed on the image display device 53 is visible over a wide viewing range.

In order to obtain a narrow display mode, the or each first light source 26A is switched ON while keeping the or each second light source 26B switched ON. As explained above, the first waveguide directs light into one or more angular ranges 432, and an observer positioned in one of these angular ranges will not be able to see an image displayed on the image display device 53, since it will be “washed out” by light from the or each first light source 26A. An observer positioned outside the or each angular range 432 will, however, be able to perceive an image displayed on the image display device 53.

The scattering structure 54 provided in the second waveguide 52 may be any suitable scattering structure that causes light to be extracted from the lower face 55 of the waveguide with a wide angular spread. In FIGS. 12(a) and 12(b) the scattering structures 54 are shown as prism-shaped indentations in the upper surface of the second waveguide, with the prisms having a triangular cross-section. However, the invention is not limited to this specific scattering structure. The prism-shaped indentations may be filled with a low refractive index material, or they may be left open to air.

In FIG. 12(a) and 12(b), the triangular scattering structures are provided only on the portions of the upper surface of the waveguide 52 that are parallel to the waveguide. They are not provided on the portions of the surface that are complimentary to the light-guiding surfaces 29, 30 of the first waveguide 25.

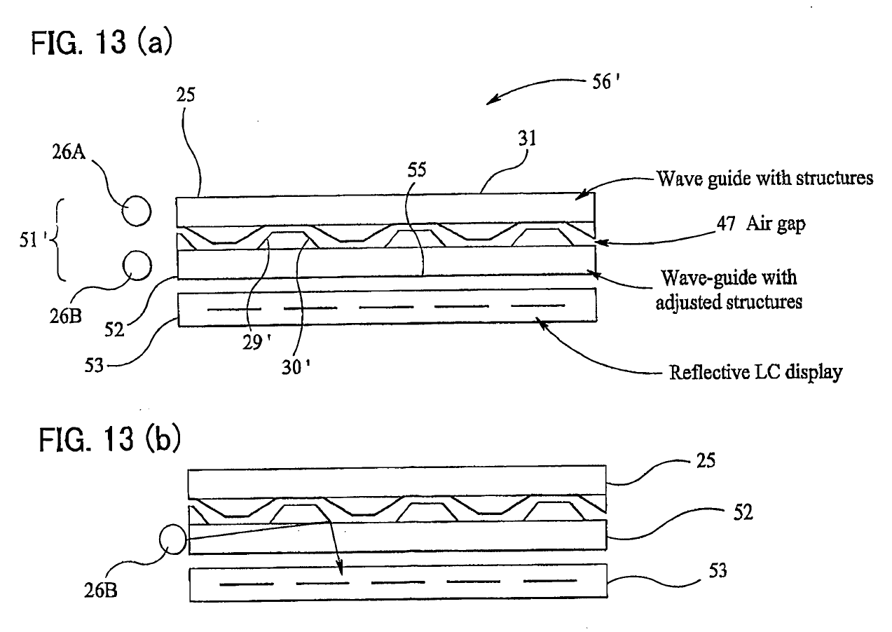

FIG. 13(a) shows a further illumination system 51′ of the present invention that corresponds generally to the illumination system 51 of FIG. 12(a). The illumination system 51′ again comprises a first waveguide 25 of the present invention, for example a waveguide as described in any one of FIGS. 6(a), 7(a), 8 or 9(a). The waveguide comprises light-directing surfaces 29, 30 that have at least first and second portions having different angles of inclination. Further description of the first waveguide 25 will not be repeated here. The first waveguide is illuminated by one or more first light sources 26A which may be, for example, a fluorescent tube arranged along an edge of the waveguide.

The illumination system 51 further comprises a second waveguide 52 arranged to direct light out of its lower face 55—that is to direct light in an angular range that is in a generally opposite direction to the direction of the range in which the first waveguide 25 directs light.

The illumination system 51′ of FIG. 13(a) differs from the illumination system 51 of FIG. 12(a) in that light propagating within the second waveguide 52 is extracted from the waveguide 52 by means of light-directing surfaces 29′, 30′ provided on the upper face 57 of the second waveguide, This is shown in FIG. 13(b). The light-directing surfaces 29′, 30′ of the second waveguide 55 are arranged to extract light from the lower face 55 of the waveguide with substantially uniform intensity over a wide angular range.

FIG. 13(a) shows the illumination system 51′ incorporated in a display 56 having a reflective image display device 53. The illumination system 51′ acts as a front light for the image display device 53.

As explained with reference to FIGS. 12(a) and 12(b), the display 56 is switchable between a wide display mode and a narrow display mode. FIG. 13(b) illustrates the wide display mode, in which the or each second light source 26B is switched ON to introduce light into the second waveguide 52, and the or each first light source 26A is switched OFF. A narrow display mode may be obtained by switching the or each first light source 26A ON while keeping the or each second light source 26B ON.

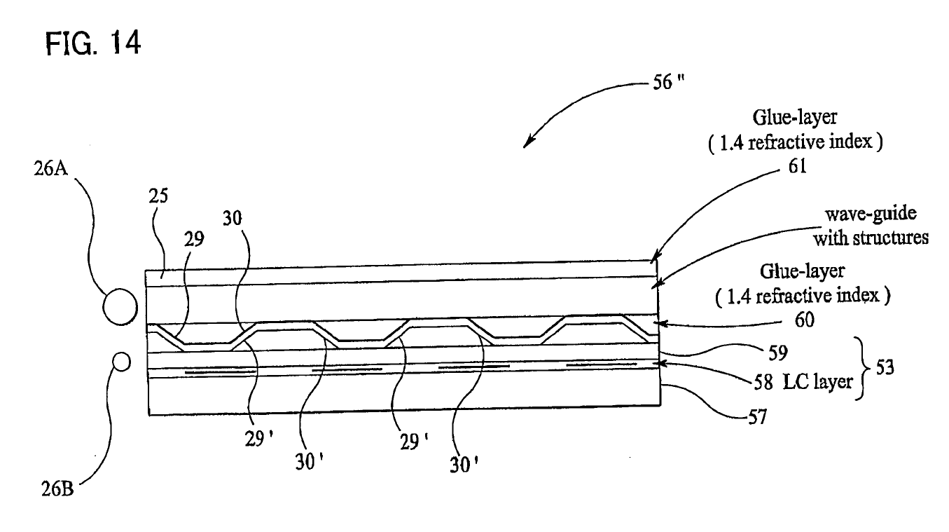

FIG. 14 is a schematic sectional view of a display 56″ according to a modified embodiment of the display 56′ of FIG. 13(a). The display 56″ again comprises a reflective image display device 53, in this embodiment formed of a lower substrate 57, an upper substrate 59, and an image display layer 58 disposed between the upper and lower substrates. The image display layer may be, for example, a liquid crystal layer.

In the display 56″, the upper substrate 59 of the image display device 53 is provided with light-directing surfaces 29′, 30′, and so also functions as the second substrate 52 of the illumination system 51′ of FIG. 13(a). The or each second light source 26B is arranged to introduce light into the upper substrate 59 of the image display device 53.

The substrate/waveguide 59 and the waveguide 25 may be made of glass (for example having a refractive index of about 1.5) or polycarbonate (for example having a refractive index of about 1.58) and are glued together by a layer 60 of transparent glue (having a refractive index of about 1.4 in this example). Other layers of the display, such as a polariser or colour filter (not shown) are attached to the front of the waveguide 25 by another glue layer 61 of refractive index 1.4.

The display 56″ of FIG. 14 is again switchable between a narrow display mode and a wide display mode, as described with reference to FIGS. 12(a) and 13(a) above. A wide display mode may be obtained when the or each second light source 26B is switched ON to introduce light into the second waveguide 52, and the or each first light source 26A is switched OFF. A narrow display mode may be obtained by switching the or each first light source 26A ON while keeping the or each second light source 26B ON.

In the embodiments of FIGS. 11(a) and 12(a), the upper surface of the second waveguide 49, 52 is preferably shaped to be complementary to the shape of the lower face 28 of the first waveguide 25 so that the second waveguide also acts as an optical compensation layer as described with reference to the embodiment of FIG. 10. In principle, the upper surface of the second waveguide 49, 52 could be made flat, but this would lead to some distortion of an image as seen by an observer.

In the embodiment of FIG. 13(a), the upper surface of the second waveguide 52 is unlikely to be exactly complementary to the lower surface 28 of the first waveguide 25, as the light-directing surfaces 29′, 30′ of the second waveguide 52 are preferably arranged to extract light from the waveguide over a wide angular range. However, the upper surface of the second waveguide 52 is to some extent complementary in shape to the shape of the lower face of the first waveguide 25, so that an observer will experience little or no distortion.

In the embodiments of FIGS. 12(a), 13(a) and 14, the size, shape and number density of the scattering structures 54 or the light-directing surfaces 29′, 30′ of the second waveguide 52 may be varied over the second waveguide 52, in accordance with the distance from a second light source 26B. This may be done to ensure that light is extracted from the lower face of the second waveguide 52 with an intensity and angular distribution that is substantially uniform over the area of the second waveguide 52.

In the embodiments of FIGS. 10, 11(a), 12(a), 13(a) and 14, the optical compensation layer 45 or second waveguide 49, 52 may be formed by, for example, moulding the waveguide or optical compensation layer, or by an etching process to define an appropriate profile for the upper surface. Alternatively, the optical compensation layer or second waveguide may be formed by depositing a structure over a planar waveguide.

What is claimed is:

1. An illumination system comprising a first waveguide and having a plurality of first light-directing surfaces provided on a first surface of the first waveguide for directing light propagating within the first waveguide into at least a first angular range while directing substantially no light into a second angular range, the first angular range being different from the second angular range;
wherein the first waveguide further comprises a plurality of second light-directing surfaces provided on the first surface of the first waveguide for directing light propagating within the first waveguide into at least a third angular range while directing substantially no light into the second angular range, the third angular range being different from the first angular range and the second angular range, and the third angular range being on the opposite side of the second angular range to the first angular range;
wherein a first light directing surface of the first waveguide comprises at least a first portion having a first angle of inclination relative to the normal axis to the first waveguide and a second portion having a second angle of inclination relative to the normal axis to the first waveguide, the second angle of inclination being different from the first angle of inclination, the first and second angles of inclination being on the same side of the normal axis as one another; and
wherein a second light directing surface of the first waveguide comprises at least a portion having a third angle of inclination relative to the normal axis to the first waveguide and a portion having a fourth angle of inclination relative to the normal axis to the first waveguide, the third angle of inclination being different from the fourth angle of inclination, and the third and fourth angles of inclination being on the same side of the normal axis as one another.

2. An illumination system as claimed in claim 1 wherein the first portion and the second portion of the first light-directing surface are planar.

3. An illumination system as claimed in claim 1 wherein a first light directing surface of the first waveguide is non-planar.

4. An illumination system as claimed in claim 1 wherein a first light-directing surface is arranged such that the first angular range subtends an angle of approximately 70° or greater.

5. An illumination system as claimed in claim 4 wherein the third and fourth angles of inclination are on the opposite side of the normal axis to the first and second angles of illumination.

6. An illumination system as claimed in claim 4 wherein the first portion and the second portion of the second light-directing surface are planar.

7. An illumination system as claimed in claim 4 wherein a second light directing surface of the first waveguide is non-planar.

8. An illumination system as claimed in claim 4 wherein a second light-directing surface is arranged such that the first angular range subtends an angle of approximately 70° or greater.

9. An illumination system as claimed in claim 1, wherein the spacing between neighbouring first light-directing surfaces varies with distance from a side edge of the first waveguide.

10. An illumination system as claimed in claim 1 wherein the light-directing surfaces are arranged in pairs, each pair including one first light-directing surface and one second light-directing surface.

11. An illumination system as claimed in claim 1 wherein the ratio between the number of first light-directing surfaces and the number of second light-directing surfaces varies with distance from a side edge of the first waveguide.

12. An illumination system as claimed in claim 1 and further comprising an optical compensation plate disposed adjacent to the first surface of the first waveguide, and having a surface complementary in shape to the shape of the first surface of the first waveguide.

13. An illumination system as claimed in claim 1 and further comprising birefringent material disposed over the first surface of the first waveguide.

14. An illumination system as claimed in claim 1 and comprising a second waveguide arranged to direct light propagating in the second waveguide into a fourth angular range, the fourth angular range being generally opposite to the first, second and third angular ranges.

15. An illumination system as claimed in claim 14 wherein the second waveguide comprises a surface shaped so as direct light propagating in the second waveguide into the fourth angular range.

16. An illumination system as claimed in claim 15 wherein the shaped surface of the second waveguide is generally complementary in shape to the first surface of the first waveguide.

17. An illumination system as claimed in claim 14 wherein a plurality of concave structures are provided in the shaped surface of the second waveguide.

18. An illumination system as claimed in claim 1 and further comprising a second waveguide arranged to direct light propagating in the second waveguide into the second angular range.

19. An illumination system as claimed in claim 18 wherein the second waveguide comprises a surface shaped so as direct light propagating in the second waveguide into the second angular range.

20. An illumination system as claimed in claim 19 wherein the shaped surface of the second waveguide is generally complementary in shape to the first surface of the first waveguide.

21. An illumination system as claimed in claim 18 wherein the second waveguide comprises a scattering structure for scattering light propagating in the second waveguide into the second angular range.

22. A display comprising: an image display device; and an illumination system disposed between the image display device and an intended viewing position of the display,
the illumination system comprising a first waveguide and having a plurality of first light-directing surfaces provided on a first surface of the first waveguide for directing light propagating within the first waveguide into at least a first angular range while directing substantially no light into a second angular range, the first angular range being different from the second angular range;
wherein the first waveguide further comprises a plurality of second light-directing surfaces provided on the first surface of the first waveguide for directing light propagating within the first waveguide into at least a third angular range while directing substantially no light into the second angular range, the third angular range being different from the first angular range and the second angular range, and the third angular range being on the opposite side of the second angular range to the first angular range;
wherein a first light directing surface of the first waveguide comprises at least a first portion having a first angle of inclination relative to the normal axis to the first waveguide and a second portion having a second angle of inclination relative to the normal axis to the first waveguide, the second angle of inclination being different from the first angle of inclination, the first and second angles of inclination being on the same side of the normal axis as one another; and
wherein a second light directing surface of the first waveguide comprises at least a portion having a third angle of inclination relative to the normal axis to the first waveguide and a portion having a fourth angle of inclination relative to the normal axis to the first waveguide, the third angle of inclination being different from the fourth angle of inclination, and the third and fourth angles of inclination being on the same side of the normal axis as one another.

23. A display as claimed in claim 22 wherein the image display device is a reflective image display device and the illumination system includes a second waveguide arranged to direct light propagating in the second waveguide into a fourth angular range, the fourth angular range being generally opposite to the first, second and third angular ranges.

24. A display as claimed in claim 23 wherein a substrate of the image display device constitutes the second waveguide of the illumination system.

25. A display comprising: an image display layer; and an illumination system includes a second waveguide arranged to direct light propagating in the second waveguide into the second angular range, the image display layer being disposed between the illumination system and an intended viewing position of the display.
